(19) United States
(12) Patent Application Publication
(10) Pub. No.: US 2007/0229216 A1
(43) Pub. Date: Oct. 4, 2007

(54) Device control system, control unit and device control method for use therewith

(75) Inventor: Junichi Yasuda, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/703,666

(22) Filed: Feb. 8, 2007

(30) Foreign Application Priority Data
Mar. 15, 2006 (JP) 2006-070119

(51) Int. Cl. G05B 23/02

(52) U.S. Cl. 340/3.42; 340/3.1; 340/10.1; 340/572.1; 700/21

(57) ABSTRACT

The present invention provides a device control system that can automatically switch the control units to eliminate the stop time of a device, and increase the utilization efficiency of the device. If the first control unit detects that the control of an RF tag reader-writer is incomplete from the activity ratio of a control part by supervising the RF tag reader-writer and supervising the periodical communication with the RF tag reader-writer, the control unit confirms whether or not there are one or more notifiable control units by referring to a control unit list. If the first control unit is notifiable to the second control unit, the first control unit notifies the information of the RF tag reader-writer to the second control unit. The second control unit returns a controllable code to the first control unit if the RF tag reader-writer is controllable by referring to the information of the RF tag reader-writer from a device information list.

### BACKGROUND OF THE INVENTION

1. Field of the Invention

The present invention relates to a device control system, a control unit and a device control method for use therewith, and more particularly to the control of an RF tag reader-writer for reading the ID (Identification) of an RF (Radio Frequency) tag, or reading or writing data by making wireless communication with the RF tag.

2. Description of the Prior Art

The RF tag reader-writer is a device that reads the ID of the RF tag, or reads or writes data by making the wireless communication with the RF tag (e.g., refer to Japanese Patent Laid-Open No. 2001-043326 and Japanese Patent Laid-Open No. 2001-092930). The RF tag reader-writer is often controlled by a control unit having the control software incorporated into a PC (Personal Computer).

The control unit controls the RF reader-writer to make the settings and read the ID of the RF tag. Also, the control unit notifies the ID and so on read from the RF tag to an application or a system to utilize the information of the RF tag in the application. Further, since the control unit can be connected to a plurality of RF tag reader-writers, the plurality of RF tag reader-writers are often connected to one control unit to make the settings or control at the same time.

### BRIEF SUMMARY OF THE INVENTION

However, with the conventional control unit for the RF tag reader-writer as described above, when a great number of RF tags are detected by a certain RF tag reader-writer, a load occurs if a large amount of control is required, so that the other RF tag reader-writer may not be controlled in some cases.

Also, with the conventional control unit, when a failure occurs, all the connected RF tag reader-writers cannot be controlled, so that the application cannot employ the information of the RF tags to be read from the RF tag reader-writers.

Conventionally, to avoid the above-mentioned problems, it is required that the settings and the configuration are manually changed when an increased load or failure occurs in the control unit.

Thus, the present invention has been achieved to solve the above-mentioned problems, and it is an object of the present invention to provide a device control system, a control unit and a device control method for use therewith which can automatically switch the control units to eliminate the stop time of a device, and increase the utilization efficiency of the device.

The present invention provides a device control system comprising of a plurality of control units for controlling a device, wherein if a concentrated load or a failure is detected in any of the plurality of control units, the control units are switched so that the control of the device by the control unit for which the concentrated load or the failure is detected may be performed by another control unit.

Also, the present invention provides a control unit for controlling a device, wherein if a concentrated load or a failure is detected in any one of a self unit and the control units, the control units are switched so that the control of the device by the control unit for which the concentrated load or the failure is detected may be performed by any one of the other control units.

Further, the present invention provides an upper-level control unit for controlling a plurality of control units, each of which controls a device, comprising means of notifying the information of the device controlled by the control unit receiving a notification of occurrence of a concentrated load or a failure to another control unit and instructing the another control unit to control the device at the time of receiving the notification of occurrence of the concentrated load or the failure in any of the plurality of control units.

Also, the present invention provides an upper-level control unit for controlling a plurality of control units, each of which controls a device, comprising means of periodically communicating with each of the plurality of control units and supervising each of the plurality of control units, and means of notifying the information of the device controlled by one control unit to the other control unit and instructing the other control unit to control the device if a concentrated load or a failure is detected in the one control unit.

The present invention provides a device control method for use in a device control system comprising of a plurality of control units for each controlling a device, comprising switching the control units so that the control of the device by the control unit for which a concentrated load or a failure is detected may be performed by the other control unit if the concentrated load or the failure is detected in any of the plurality of control units.

Moreover, the present invention provides a recording medium recording a program for a device control method for use in a control unit for controlling a device, the program being executed on a computer, the program comprising a process of notifying the information of the device controlled by the control unit to the other control unit if any occurrence of the concentrated load or the failure in the control unit is detected, a process of determining whether or not the device is controllable by the control unit if the information of the device is sent from the other control unit, and a process of trying to control the device if the device is determined to be controllable by the control unit.

Also, the present invention provides another recording medium recording a program for a device control method for use in an upper-level control unit for controlling a plurality of control units for each controlling a device, the program being executed on a computer, the program comprising a process of notifying the information of the device controlled by the control unit receiving a notification of occurrence of a concentrated load or a failure to the other control unit and instructing the other control unit to control the device at the time of receiving the notification of occurrence that the concentrated load or the failure occurs in any of the plurality of control units.

Also, the present invention provides another recording medium recording a program for a device control method for use in an upper-level control unit for controlling a plurality of control units for each controlling a device, the program being executed on a computer, the program comprising a process of periodically communicating with each of the plurality of control units to supervise each of the plurality of control units, and a process of notifying the information of the device controlled by one control unit to the other control unit and instructing the other control unit to control the device at the time of detecting the occurrence of the concentrated load or the failure in the one control unit.

That is, the device control system of the present invention detects a load or a failure of the control unit for the device such as an RF (Radio Frequency) tag reader-writer and automatically switches the control units for controlling the device such as RF tag reader-writer, making it possible to use continually the device such as RF tag reader-writer.

In the device control system of the present invention, it is possible to increase the utilization efficiency of the RF tag reader-writer by automatically switching the control units to eliminate the stop time of the RF tag reader-writer. Also, in the RF tag reader-writer control system of the present invention, it is possible to reduce the manual operation and lower the cost because the control units are automatically switched.

More specifically, in a first device control system of the present invention, one of the plurality of control units detects that the control of the RF tag reader-writer is incomplete from the activity ratio of a control part within the control unit by supervising the RF tag reader-writer and supervising the periodical communication with the RF tag reader-writer, whereby even if a load is concentrated on the control unit, the other control unit automatically controls the RF tag reader-writer, making it possible to continue to use the RF tag reader-writer, and for the external system to continually use the information of the RF tag.

Also, in the first device control system of the present invention, the switching of the control occurs at the stage of detecting a load of the control unit, whereby the time for which the RF tag reader-writer is stopped can be shorter than the manual operation of detecting the load and changing the configuration. Further, in the first device control system of the present invention, since the control units are automatically changed, the cost of changing the configuration can be lower than the manual operation of changing the configuration.

In a second device control system of the present invention, all the information of the RF tag reader-writer including the setting information and the status information is notified when the load is increased, and a device information list is dynamically updated, whereby it is not required that all the information of the RF tag reader-writer is registered beforehand. Since the control unit holds only the information of the RF tag reader-writer controlled by itself, the amount of device information list can be reduced, and the connection of the RF tag reader-writer can be dynamically changed.

In a third device control system of the present invention, the control units periodically communicate and supervise each other, the RF tag reader-writers can be switched even if a failure occurs in any of the plurality of control units, whereby all the RF tag reader-writers controlled by the control unit in which the failure occurs can be continually used.

In a fourth device control system of the present invention, using an upper-level control unit for the control units that control the RF tag reader-writer, the information can be continually acquired from the RF tag without changing the external system at all. Also, in the fourth device control system of the present invention, the lower-level control unit needs to have only the information of the upper-level control unit, whereby the amount of information is reduced. Further, in the fourth device control system of the present invention, the switching of the control is made by the upper-level control unit, whereby it is not required that the state is shared between the lower-level control units.

In a fifth device control system of the present invention, since the periodical communication is made between the upper-level control unit and the lower-level control units to supervise the control units, it is possible to continually acquire the information of the RF tag even if a failure occurs in the lower-level control unit.

With the above configuration and operation, the present invention provides the effects that the stop time of the device can be eliminated by automatically switching the control units, and the utilization efficiency of the device can be increased.

### BRIEF DESCRIPTION OF THE DRAWINGS

FIG. 1 is a block diagram showing the configuration of a device control system according to a first embodiment of the present invention;

FIG. 2A is a view showing the organization of a control unit list 11 of FIG. 1, FIG. 2B is a view showing the organization of a control unit list 21 of FIG. 1, FIG. 2C is a view showing the organization of a device information list 12 of FIG. 1, and FIG. 2D is a view showing the organization of a device information list 22 of FIG. 1;

FIG. 3 is a flowchart showing the operation of the control units of FIG. 1;

FIG. 4A is a view showing the organization of a control unit list 11 according to a second embodiment of the present invention, FIG. 4B is a view showing the organization of a control unit list 21 according to the second embodiment of the present invention, FIG. 4C is a view showing the organization of a device information list 12 according to the second embodiment of the present invention, and FIG. 4D is a view showing the organization of a device information list 22 according to the second embodiment of the present invention;

FIG. 5 is a flowchart showing the operation of the control units according to the second embodiment of the present invention;

FIG. 6 is a flowchart showing the operation of the control units according to a third embodiment of the present invention;

FIG. 7 is a block diagram showing the configuration of a device control system according to a fourth embodiment of the present invention;

FIG. 8A is a view showing the organization of a control unit list 11 of FIG. 7, FIG. 8B is a view showing the organization of a control unit list 21 of FIG. 7, FIG. 8C is a view showing the organization of a control unit list 61 of FIG. 7, FIG. 8D is a view showing the organization of a device information list 12 of FIG. 7, FIG. 8E is a view showing the organization of a device information list 22 of FIG. 7 and FIG. 8F is a view showing the organization of a device information list 62 of FIG. 7;

FIG. 9 is a flowchart showing the operation of the control units of FIG. 7;

FIG. 10 is a flowchart showing the operation of the control units of FIG. 7; and

FIG. 11 is a flowchart showing the operation of the control units according to a fifth embodiment of the present invention.

### DETAILED DESCRIPTION OF THE PREFERRED EMBODIMENTS

The preferred embodiments of the present invention will be described below with reference to the drawings.

### Embodiment 1

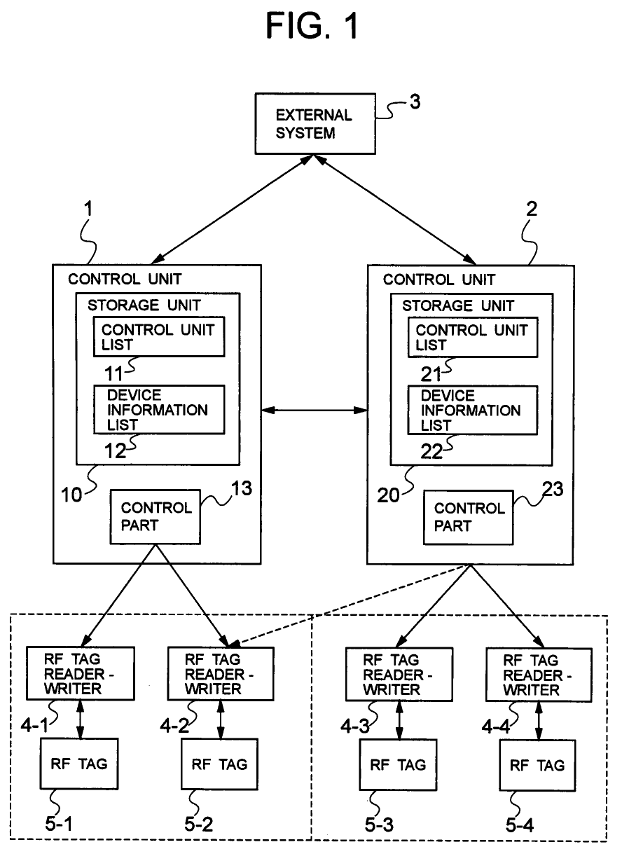

FIG. 1 is a block diagram showing the configuration of a device control system according to a first embodiment of the present invention. In FIG. 1, the device control system according to the first embodiment of the present invention is the system for controlling a device such as an RF (Radio Frequency) tag reader-writer, and comprises the control units 1 and 2, an external system 3, the RF tag reader-writers 4-1 to 4-4, and the RF tags 5-1 to 5-4.

A control unit 1 is connected to the RF tag reader-writers 4-1 and 4-2, and supervises and controls the RF tag reader-writers 4-1 and 4-2. A control unit 2 is connected to the RF tag reader-writers 4-3 and 4-4, and supervises and controls the RF tag reader-writers 4-3 and 4-4. The control units 1 and 2 can be connected or disconnected to or from the RF tag reader-writers 4-1 to 4-4 at any time.

The RF tag reader-writers 4-1 to 4-4 can read the ID (Identification) of the RF rags 5-1 to 5-4, and read or write data by making the wireless communication with the RF tags 5-1 to 5-4.

The control units 1 and 2 are connected to each other and can exchange the information. Also, the external system 3 such as an application or a system is the system for using the information of the RF tags 5-1 to 5-4, is connected to the control units 1 and 2 via a network, and can acquire the information of the RF tags 5-1 to 5-4 from the control units 1 and 2.

The control units 1 and 2 comprise the control unit lists 11 and 21 and the device information lists 12 and 22, the storage units 10 and 20 for holding the programs, and the control parts 13 and 23 for executing the program of the storage units 10 and 20, respectively. The control parts 13 and 23 are the parts for controlling the RF tag reader-writers 4-1 to 4-4. A control part 13 controls the RF tag reader-writers 4-1 and 4-2 and a control part 23 controls the RF tag reader-writers 4-3 and 4-4. Also, the control units 1 and 2 can acquire the information such as the status of the control parts 13 and 23 and activity ratio.

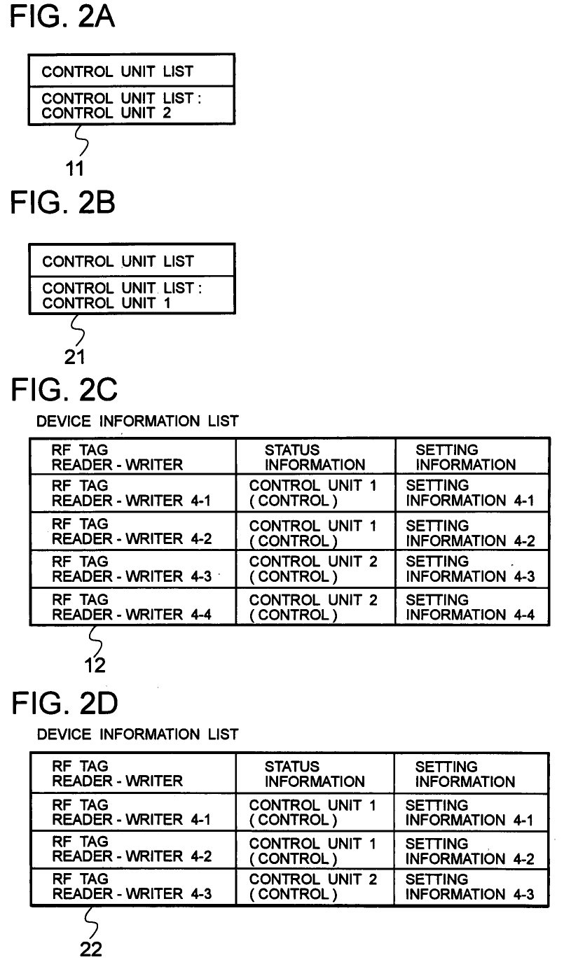

FIG. 2A is a view showing the organization of a control unit list 11 of FIG. 1, FIG. 2B is a view showing the organization of a control unit list 21 of FIG. 1, FIG. 2C is a view showing the organization of a device information list 12 of FIG. 1, and FIG. 2D is a view showing the organization of a device information list 22 of FIG. 1.

Referring to FIGS. 2A and 2B, the control unit lists 11 and 21 can register the information concerning the other control unit operating within the same system. In this embodiment, the control unit 2 is registered in the control unit list 11 and the control unit 1 is registered in the control unit list 21.

The device information lists 12 and 22 can record the list of the RF tag reader-writers 4-1 to 4-4 and the setting information and state information of the RF tag reader-writers 4-1 to 4-4. In this embodiment, the device information lists 12 and 22 register the information of the RF tag reader-writers 4-1 to 4-4 and respective state information and setting information. The RF tag reader-writers 4-1 to 4-4 are set up by the respective setting information 4-1 to 4-4.

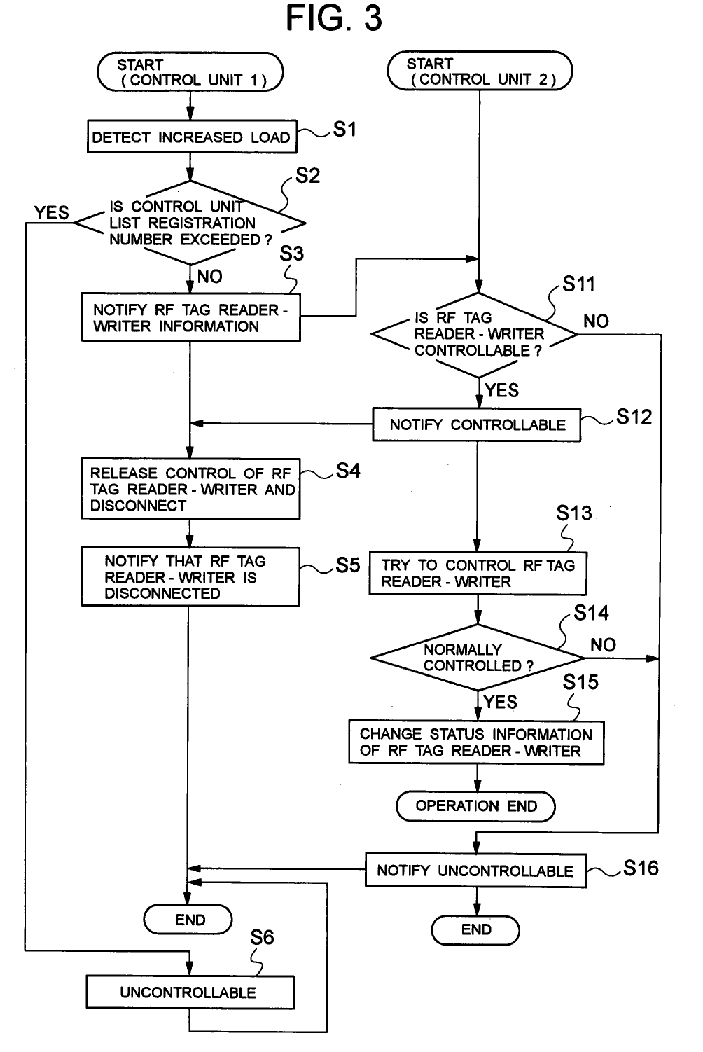

FIG. 3 is a flowchart showing the operation of the control units 1 and 2 of FIG. 1. Referring to FIGS. 1 to 3, the operation of the device control system according to the first embodiment of the present invention will be described below. An operation example of switching the control over the RF tag reader-writers where a load on the control unit 1 is increased by the RF tag reader-writer 4-1 will be described below. A process as shown in FIG. 3 is implemented by executing a program held in the storage units 10 and 20 with the control parts 13 and 23.

When a large quantity of RF tag 5-1 exists in a reading range of the RF tag reader-writer 4-1, or when a complex control is made, the control part 13 has an increased load to control the RF tag reader-writer 4-1, so that the control of the RF tag reader-writer 4-2 may become incomplete. In this case, the control unit 1 detects that the control of the RF tag reader-writer 4-2 becomes incomplete by supervising the activity ratio of the control part 13 or the RF tag reader-writer 4-2 and supervising the periodical communication with the RF tag reader-writer 4-2 (step S1 of FIG. 3).

The control unit 1 confirms whether or not one or more notifiable control units exist by referring to the control unit list 11, if the load is detected. Since the control unit 2 is registered in the control unit list 11, the control unit 1 is notifiable to the control unit 2 (step S2 of FIG. 3), and notifies the information of the RF tag reader-writer 4-2 to the control unit 2 (step S3 of FIG. 3).

The control unit 2 determines whether or not the RF tag reader-writer 4-2 is controllable by referring to the information of the RF tag reader-writer 4-2 from the device information list 22 (step S11 of FIG. 3). If controllable, the control unit 2 returns a controllable code to the control unit 1 (step S12 of FIG. 3). If there is no information of the RF tag reader-writer 4-2 in the device information list 22, or if the RF tag reader-writer 4-2 is uncontrollable, the control unit 2 returns an uncontrollable code to the control unit 1 (step S16 of FIG. 3).

If the code that the control unit 2 can control the RF tag reader-writer 4-2 is returned, the control unit 1 releases the control of the RF tag reader-writer 4-2, and cuts off the connection (step S4 of FIG. 3). Next, the control unit 1 notifies the control unit 2 that the RF tag reader-writer 4-2 is disconnected (step S5 of FIG. 3).

If the control unit 2 receives a notification that the RF tag reader-writer 4-2 is disconnected from the control unit 1, the control unit 2 picks up the setting information 4-2 by referring to the device information list 22, connects to the RF tag reader-writer 4-2 using the setting information 4-2, and tries to control the RF tag reader-writer (step S13 of FIG. 3). Then, the control unit 2 confirms whether or not the RF tag reader-writer is normally controlled (step S14 of FIG. 3).

If the RF tag reader-writer 4-2 is controllable, the control unit 2 rewrites the status information of the RF tag reader-writer 4-2 in the device information list 22 with the status information that the control unit 2 controls, and notifies its information to the control unit 1. The control unit 1, which has received the notification from the control unit 2, rewrites the status information of the RF tag reader-writer 4-2 in the device information list 12 with the status information that the control unit 2 controls (step S15 of FIG. 3), and the operation is ended.

Through the above process, the control unit 1 controls the RF tag reader-writer 4-1, and the control unit 2 controls the RF tag reader-writers 4-2 to 4-4. Thereby, the external system 3 can acquire the information of the RF tags 5-1 to 5-4 from the RF tag reader-writers 4-1 to 4-4 through the control units 1 and 2.

If the control unit 2 cannot control the RF tag reader-writer 4-2, the control unit 2 notifies the control unit 1 that the RF tag reader-writer 4-2 is uncontrollable (step S16 of FIG. 3). If the control unit 2 cannot control the RF tag reader-writer 4-2, the control unit 1 designates the next registered control unit. And the control unit 1 searches the control unit list 11 again (step S2 of FIG. 3). If there is any other control unit to be notified, the RF tag reader-writers 4-1 to 4-4 can be switched by repeating the same procedure.

However, if there is no more control unit to be notified in the control unit list 11, the control unit 1 rewrites the status information of the RF tag reader-writer 4-2 in the device information list 12 to be uncontrollable (step S6 of FIG. 3), and the operation is ended. By performing these operations, the RF tag reader-writers 4-1 to 4-4 can be switched even if there are two or more control units in this embodiment.

Thus, in this embodiment, even if the load is concentrated on the control unit 1, the other control unit 2 automatically controls the RF tag reader-writer 4-2 to allow the continual use of the RF tag reader-writer 4-2, and the external system 3 can continually acquire and use the information of the RF tag 5-2.

Also, the switching of control occurs at a stage where the load of the control unit 1 is detected in this embodiment, whereby the time for which the RF tag reader-writer 4-2 is stopped can be smaller than where the load is manually detected to change the configuration. Further, the configuration is automatically changed between the control units in this embodiment, whereby the cost of changing the configuration can be smaller than where the configuration is manually changed.

Though two control units are provided in this embodiment, the number of control units is not limited. Though the control of only one RF reader-writer is changed in this embodiment, the control of two or more RF tag reader-writers may be changed. For example, in a case where the RF tag reader-writers 4-1 to 4-4 are connected to the control unit 1, and if the load of the control unit 1 is increased by the RF tag reader-writer 4-1, the control of the RF tag reader-writers 4-2 to 4-4 may be switched into the control unit 2.

To connect the RF tag reader-writers 4-1 to 4-4 and the control units 1, 2 various methods such as a network and a USB (Universal Serial Bus) may be employed in this embodiment, without depending on the connecting method.

Further, in this embodiment, when the load of the control unit 1 on which the load is concentrated is reduced, the control of the RF tag reader-writer 4-2 may be restored to the original control unit 1 by notifying that the load is reduced. Furthermore, the control unit for controlling the RF tag reader-writer may be manually restored at any time in this embodiment. For example, the control of the RF tag reader-writer 4-2 controlled by the control unit 2 may be automatically restored to the control unit 1 when the load of the control unit 1 is reduced.

Though the sequence of the control units to be notified is selected to be the sequence in which the control units are arranged in the control unit lists 11 and 12, the order of priority of the control units 1 and 2 for controlling the RF tag reader-writers 4-1 to 4-4 may be registered in the device information lists 11 and 21, and the control unit 1, 2 for controlling may be selected in accordance with the order of priority.

If the load of the control unit having higher order of priority than the control unit for controlling at present is reduced, the control units 1 and 2 may notify each other and the control unit having higher order of priority may control the RF tag reader-writer.

Though the RF tag reader-writers 4-1 to 4-4 are the same type in this embodiment, the control of the RF tag reader-writers of different types may be switched. Also, though the control units 1 and 2 are separated from the RF tag reader-writers 4-1 to 4-4 in this embodiment, the control units 1 and 2 may be contained within the RF tag reader-writers 4-1 to 4-4.

If the load is high even after the end of operation, the control of the RF tag reader-writer can be switched to another control unit again, but the same process may be repeated. An object to be controlled by the control unit is the RF tag reader-writer, but may be replaced with a device such as a sensor or the like controllable by the control unit.

Though the connection between the control units 1, 2 and the external system 3 is made via the network in this embodiment, various methods such as a USB and an internal bus and so on may be employed. Also, though the external system 3 is arranged outside the control units 1 and 2 in this embodiment, the external system 3 may be arranged inside the control unit 1, 2.

### Embodiment 2

A second embodiment of the present invention will be described below with reference to the drawings. The configuration of a device control system, not shown, according to the second embodiment of the present invention is the same as the device control system according to the first embodiment of the present invention as shown in FIG. 1.

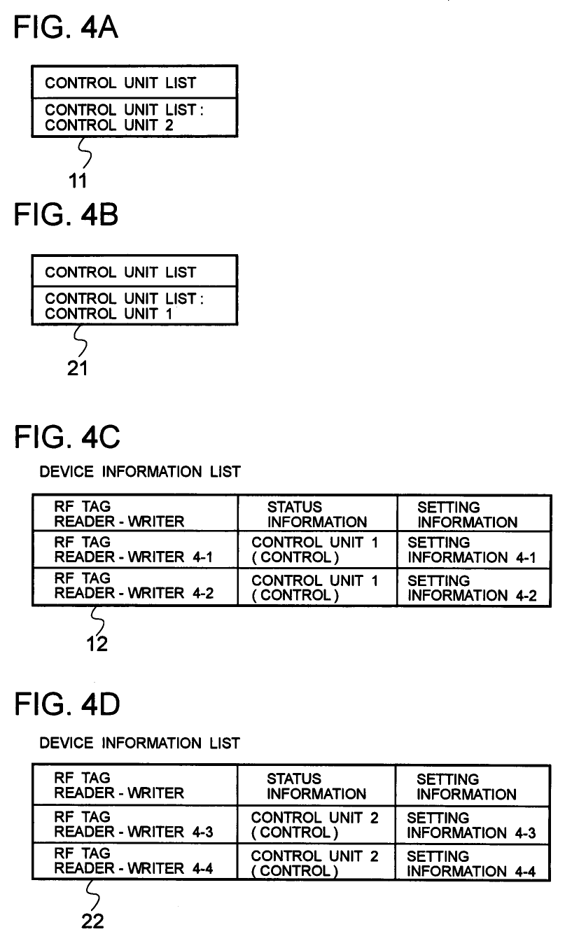

FIG. 4A is a view showing the organization of a control unit list 11 according to the second embodiment of the present invention, FIG. 4B is a view showing the organization of a control unit list 21 according to the second embodiment of the present invention, FIG. 4C is a view showing the organization of a device information list 12 according to the second embodiment of the present invention, and FIG. 4D is a view showing the organization of a device information list 22 according to the second embodiment of the present invention.

Referring to FIGS. 4C and 4D, the information registered in the device information lists 12 and 22 are different in this embodiment. Only the information of the RF tag reader-writers 4-1 and 4-2 are registered in the device information list 12, while only the information of the RF tag reader-writers 4-3 and 4-4 are registered in the device information list 22.

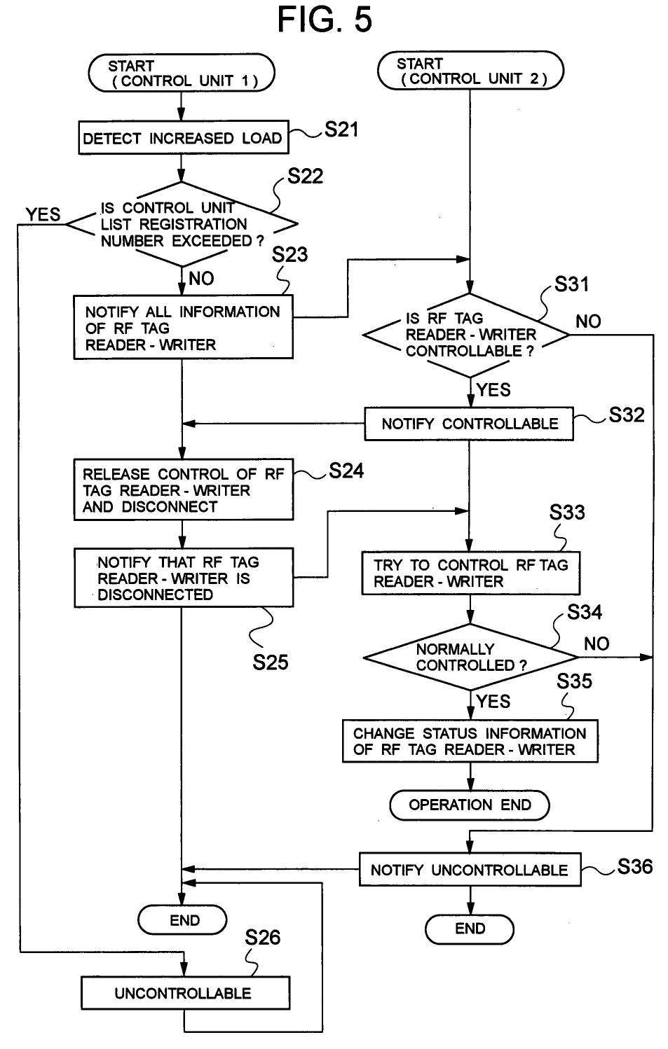

FIG. 5 is a flowchart showing the operation of the control units 1 and 2 according to the second embodiment of the present invention. Referring to FIG. 1, FIGS. 4A to 4D and FIG. 5, the operation of the device control system according to the second embodiment of the present invention will be described below. The operation of the device control system according to the second embodiment is different from the operation of the device control system according to the first embodiment of the present invention in a part for notifying all the information of the RF tag reader-writer including the setting information and the status information when the load is increased and a part for dynamically updating the device information lists 12 and 22. In the following an instance where the load of the control unit 1 is increased by the RF tag reader-writer 4-1 will be described below. A process as shown in FIG. 5 is implemented by executing a program held in the storage units 10 and 20 with the control parts 13 and 23.

When a large quantity of RF tag 5-1 exists in a reading range of the RF tag reader-writer 4-1, or when a complex control is made, the control part 13 has an increased load to control the RF tag reader-writer 4-1, so that the control of the RF tag reader-writer 4-2 may become incomplete. In this case, the control unit 1 detects that the control of the RF tag reader-writer 4-2 becomes incomplete by supervising the activity ratio of the control part 13 or the RF tag reader-writer 4-2 and supervising the periodical communication with the RF tag reader-writer 4-2 (step S21 of FIG. 5).

The control unit 1 confirms whether or not one or more notifiable control units exist by referring to the control unit list 11, if the load is detected. Since the control unit 2 is registered in the control unit list 11, the control unit 1 can notify the control unit 2 (step S22 of FIG. 5), and notifies all the information of the RF tag reader-writer 4-2 to the control unit 2 (step S23 of FIG. 5).

If the control unit 2 receives a notification from the control unit 1, the control unit 2 adds the setting information and the status information of the RF tag reader-writer 4-2 to the device information list 22, and determines whether or not the RF tag reader-writer 4-2 can be controlled using its information (step S31 of FIG. 5). If the RF tag reader-writer 4-2 is controllable, the control unit 2 returns a controllable code to the control unit 1 (step S32 of FIG. 5). If there is no information of the RF tag reader-writer 4-2 in the device information list 22, or if the RF tag reader-writer 4-2 is uncontrollable, the control unit 2 returns an uncontrollable code to the control unit 1 (step S36 of FIG. 5).

If a code that the control unit 2 can control the RF tag reader-writer 4-2 is returned, the control unit 1 releases the control of the RF tag reader-writer 4-2, and cuts off the connection (step S24 of FIG. 5). Next, the control unit 1 notifies the control unit 2 that the RF tag reader-writer 4-2 is disconnected (step S25 of FIG. 5).

If the control unit 2 receives a notification that the RF tag reader-writer 4-2 is disconnected from the control unit 1, the control unit 2 picks up the setting information 4-2 by referring to the device information list 22, connects to the RF tag reader-writer 4-2 using the setting information 4-2, and tries to control the RF tag reader-writer (step S33 of FIG. 5). Then, the control unit 2 confirms whether or not the RF tag reader-writer is normally controlled (step S34 of FIG. 5).

If the control unit 2 can control the RF tag reader-writer 4-2, it rewrites the status information of the RF tag reader-writer 4-2 in the device information list 22 with the status information that the control unit 2 controls, and notifies its information to the control unit 1. The control unit 1, which has received a notification from the control unit 2, rewrites the status information of the RF tag reader-writer 4-2 in the device information list 12 with the status information that the control unit 2 controls (step S35 of FIG. 5), and the operation is ended.

Through the above process, the control unit 1 controls the RF tag reader-writer 4-1, and the control unit 2 controls the RF tag reader-writers 4-2 to 4-4. Thereby, the external system 3 can acquire the information of the RF tags 5-1 to 5-4 from the RF tag reader-writers 4-1 to 4-4 through the control units 1 and 2.

If the control unit 2 cannot control the RF tag reader-writer 4-2, it notifies the control unit 1 that the RF tag reader-writer 4-2 is uncontrollable (step S36 of FIG. 5). If the control unit 2 cannot control the RF tag reader-writer 4-2, the control unit 1 designates the next registered control unit. And the control unit 1 searches the control unit list 11 again (step S22 of FIG. 5). If there is any other control unit to be notified, the RF tag reader-writers 4-1 to 4-4 can be switched by repeating the same procedure.

However, if there is no more control unit to be notified in the control unit list 11, the control unit 1 rewrites the status information of the RF tag reader-writer 4-2 in the device information list 12 to be uncontrollable (step S26 of FIG. 5), and the operation is ended. By performing these operations, the RF tag reader-writers 4-1 to 4-4 can be switched even if there are two or more control units in this embodiment.

By performing these processes, the control unit 2 can control the RF tag reader-writer 4-2 not registered in advance in the device information list 22. Thereby, the external system 3 can continually acquire the information of the RF tag from the RF tag reader-writer 4-2 in this embodiment.

Thus, in this embodiment, it is not required that all the information of the RF tag reader-writer is registered in advance by notifying all the information of the RF tag reader-writer including the setting information and the status information and dynamically updating the device information lists 12 and 22 when the load is increased. Since the control unit needs to hold only the information of the RF tag reader-writer controlled by itself, the amount of device information lists can be reduced. Also, the connection with the RF tag reader-writer can be dynamically changed.

### Embodiment 3

A third embodiment of the present invention will be described below. The configuration of a device control system according to the third embodiment of the present invention is the same as the device control system according to the first embodiment of the present invention as shown in FIG. 1, except that the periodical communication is made between the control units 1 and 2 to supervise the control units 1 and 2 mutually. The control unit 2 can detect that the control unit 1 fails if there is no notification from the control unit 1 or there is no reply to the notification.

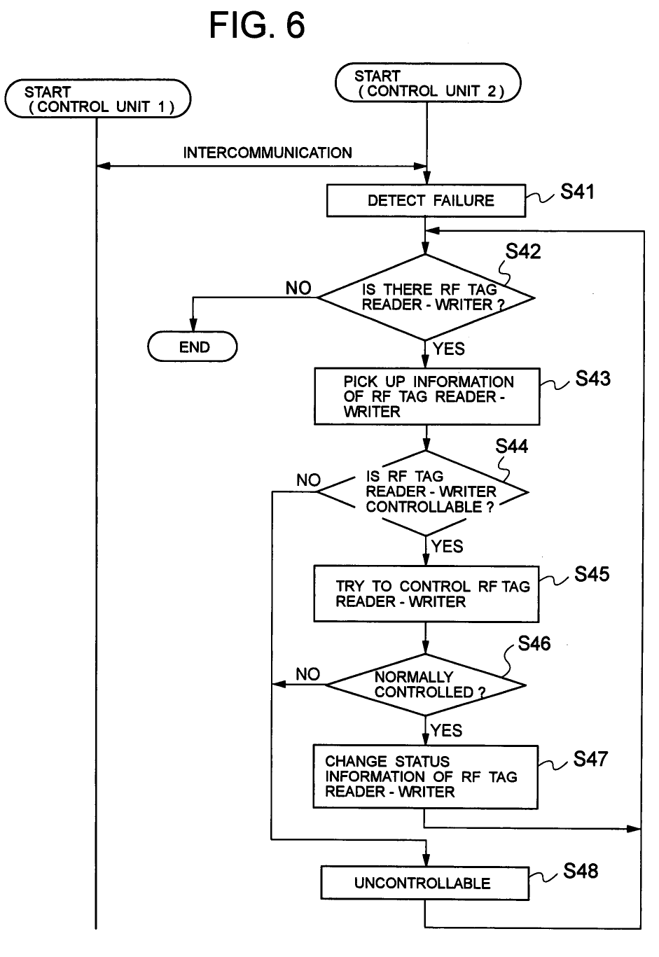

FIG. 6 is a flowchart showing the operation of the control units 1 and 2 according to the third embodiment of the present invention. Referring to FIGS. 1 and 6, the operation of the control units 1 and 2 according to the third embodiment of the present invention will be described below. A process as shown in FIG. 6 is implemented by executing a program held in the storage units 10 and 20 with the control parts 13 and 23. The switching of the control over the RF tag reader-writers 4-1 to 4-4 when the control unit 1 fails will be described below.

If the control unit 1 fails, the control unit 1 cannot make a notification of supervision or a reply of the notification of supervision to the control unit 2. The control unit 2 detects that the control unit 1 fails because it cannot make the communication for supervision with the control unit 1 (step S41 of FIG. 6).

The control unit 2 searches the device information list 22 for the RF tag reader-writers 4-1 and 4-2 controlled by the control unit 1 (step S42 of FIG. 6). If the RF tag reader-writers 4-1 and 4-2 exist, it is registered in the device information list 22 that the control unit 1 controls the RF tag reader-writers 4-1 and 4-2, whereby the control unit 2 firstly picks up the setting information 4-1 (step S43 of FIG. 6).

The control unit 2 verifies the setting information 4-1 and determines whether or not the RF tag reader-writer 4-1 is controllable (step S44 of FIG. 6). If controllable, the control unit 2 tries to control the RF tag reader-writer 4-1 using the setting information 4-1 (step S45 of FIG. 6). If the control unit 2 can normally control the RF tag reader-writer 4-1 (step S46 of FIG. 6), it rewrites the status information of the RF tag reader-writer 4-1 in the device information list 22 with the status information that control unit 2 controls (step S47 of FIG. 6).

If the control unit 2 cannot control the RF tag reader-writer 4-1, it rewrites the status information of the RF tag reader-writer 4-1 in the device information list 22 with the status information that the control unit 2 is uncontrollable (step S48 of FIG. 6).

Next, the control unit 2 checks the device information list 22. If the RF tag reader-writer controlled by the control unit 1 does not exist (step S42 of FIG. 6), the operation is ended. Also, if the RF tag reader-writer controlled by the control unit 1 exists (step S42 of FIG. 6), the control unit 2 repeats the same procedure from the step S43. Thereby, the control unit 2 controls the RF tag reader-writers 4-1 to 4-4, and the external system 3 can acquire the information of the RF tags 5-1 to 5-4.

Thus, in this embodiment, since the periodical communication is made between the control units 1 and 2 to supervise the control units 1 and 2 mutually, the switching between the RF tag reader-writers 4-1 to 4-4 can be made even if the control units 1 or 2 fails, whereby it is possible to continue to use all the RF tag reader-writers 4-1 and 4-2 controlled by the control unit 1 that fails.

In this embodiment, after the recovery from failure, the original control unit 1 regains control, or control may be returned at any time. Though two control units are provided in this embodiment, two or more control units maybe employed. Further, even if the control unit 2 fails, the control unit 1 may control the RF tag reader-writers 4-3 and 4-4. Furthermore, the control units to be switched may be assigned the order of priority and switched in accordance with the order of priority in this embodiment.

### Embodiment 4

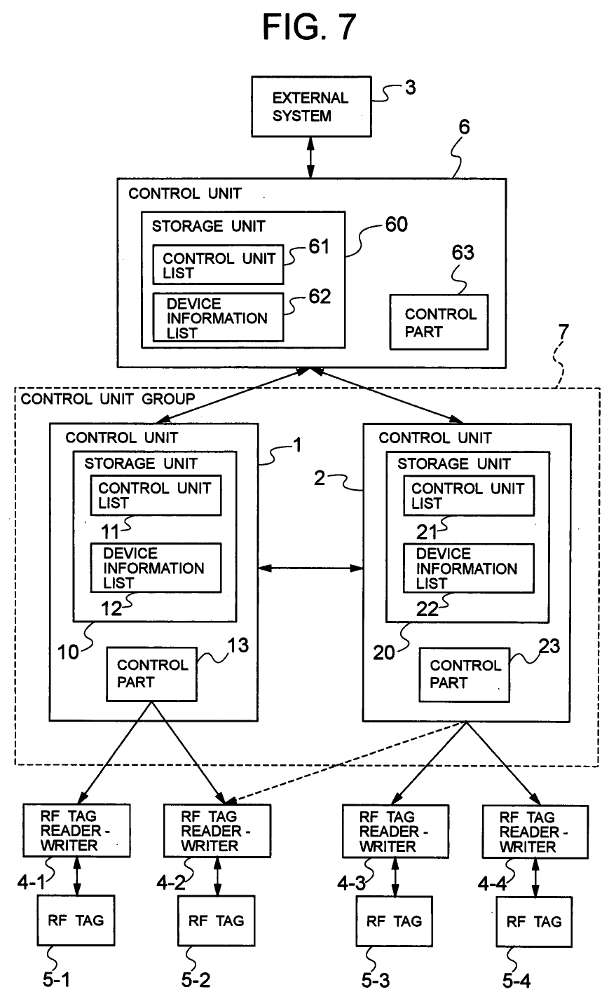

FIG. 7 is a block diagram showing the configuration of a device control system according to a fourth embodiment of the present invention. In FIG. 7, the configuration of the device control system according to the fourth embodiment of the present invention is the same as the first embodiment of the present invention as shown in FIG. 1, except that a control unit 6 is provided and a control unit group 7 consists of the control units 1 and 2, wherein the same components are designated by the same numerals. The operation of the same components is the same as the first embodiment of the present invention.

The control unit 6 comprises a storage unit 60 for holding a control unit list 61, a device information list 62 and a program, and a control part 63. In this case, the control unit 6 operates as an upper-level control unit of the control units 1 and 2, and can control the lower-level control units 1 and 2. Also, the control unit 6 can connect to the external system 3 and notify the information of the RF tags 5-1 to 5-4 that can be acquired through the control units 1 and 2 to the external system 3.

Similarly, the control unit 6 can exchange the information with the control units 1 and 2 by connecting to the control units 1 and 2. Also, the control unit 6 periodically communicates with the control units 1 and 2 to supervise the control units 1 and 2.

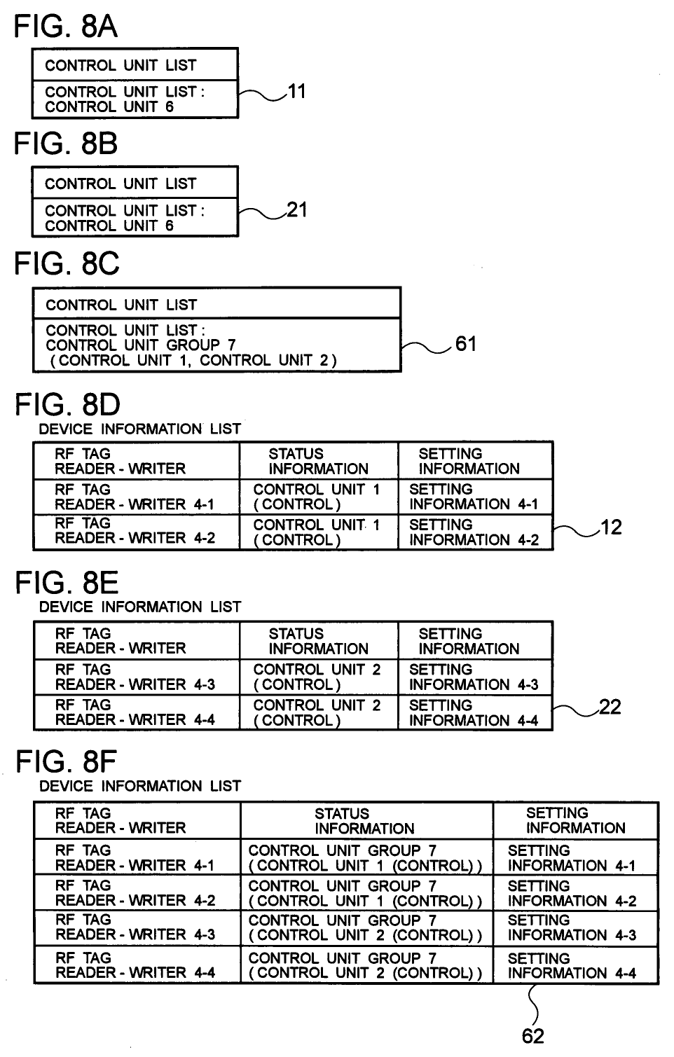

FIG. 8A is a view showing the organization of a control unit list 11 of FIG. 7, FIG. 8B is a view showing the organization of a control unit list 21 of FIG. 7, FIG. 8C is a view showing the organization of a control unit list 61 of FIG. 7, FIG. 8D is a view showing the organization of a device information list 12 of FIG. 7, FIG. 8E is a view showing the organization of a device information list 22 of FIG. 7, and FIG. 8F is a view showing the organization of a device information list 62 of FIG. 7.

Referring to FIGS. 8A to 8E, the information registered in the control unit lists 11 and 21 and the device information lists 12 and 22 are different in this embodiment. The control unit 6 that is the upper-level control unit is registered in the control unit lists 11 and 12. Also, the information of the RF tag reader-writers 4-1 and 4-2 are registered in the device information list 12, and the information of the RF tag reader-writers 4-3 and 4-4 are registered in the device information list 22.

The control unit group 7 is registered in the control unit list 61 held by the control unit 6 that is the upper-level control unit, and the control units 1 and 2 are registered in the control group 7. The control unit group is one group consisting of a plurality of control units 1 and 2. It is supposed that the control units 1 and 2 belonging to the same group can connect, disconnect or control the same RF tag reader-writer. In this embodiment, it is supposed that the control units 1 and 2 belonging to the same group can control the RF tag reader-writers 4-1 to 4-4.

All the RF tag reader-writers 4-1 to 4-4 controlled by the lower-level control units 1 and 2 are registered in the device information list 62 held by the control unit 6 that is the upper-level control unit. Also, the control units 1 and 2 controlling the RF tag reader-writers 4-1 to 4-4 and the control unit group 7 are registered as respective status information in the device information list 62. Further, the setting information 4-1 to 4-4 is also held in the device information list 62.

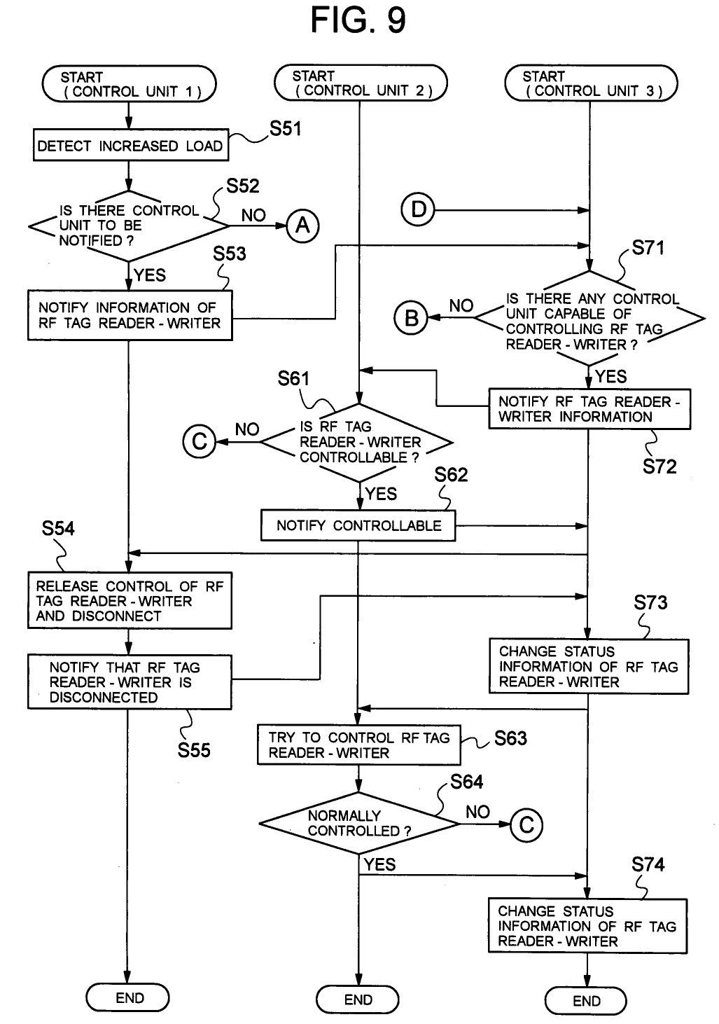

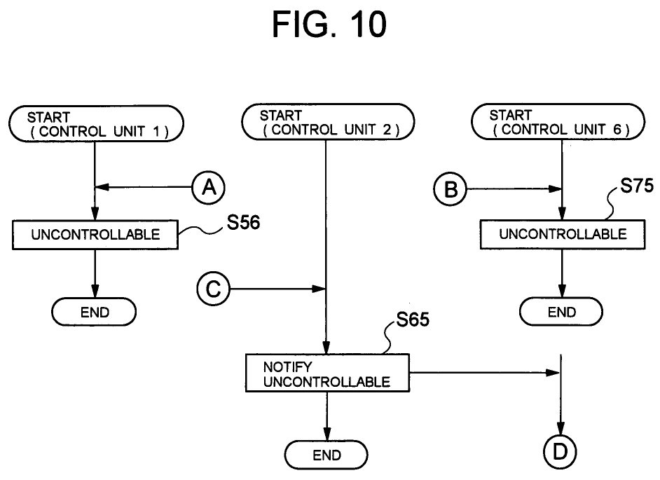

FIGS. 9 and 10 are the flowcharts showing the operation of the control units 1, 2 and 6 of FIG. 7. Referring to FIGS. 7 to 10, the operation of the control units 1, 2 and 6 according to the fourth embodiment of the present invention will be described below. A process as shown in FIGS. 9 and 10 is implemented by executing a program held in the storage units 10, 20 and 60 with the control parts 13, 23 and 63. An operation of switching the control of the RF tag reader-writers 4-1 to 4-4 where a load on the control unit 1 is increased by the RF tag reader-writer 4-1 will be described below.

When a large quantity of RF tag 5-1 exists in a reading range of the RF tag reader-writer 4-1, or when a complex control is made, the control part 13 has an increased load to control the RF tag reader-writer 4-1, so that the control of the RF tag reader-writer 4-2 may become incomplete. In this case, the control unit 1 detects that the control of the RF tag reader-writer 4-2 becomes incomplete by supervising the activity ratio of the control part 13 or the RF tag reader-writer 4-2 and supervising the periodical communication with the RF tag reader-writer 4-2 (step S51 of FIG. 9).

If the control unit 1 detects that the load is increased, and confirms that the control unit 6 is registered in the control unit list 11 (step S52 of FIG. 9), it sends the information of the RF tag reader-writer 4-2 to the control unit 6 (step S53 of FIG. 9). If there is no control unit registered in the control unit list 11 (step S52 of FIG. 9), the control unit 1 is treated as uncontrollable (step S56 of FIG. 10), and the operation is ended.

If the control unit 6 receives a notification from the control unit 1, the control unit 6 checks whether or not any control unit other than the control unit 1 can control the RF tag reader-writer 4-2 from the device information list 62. The control unit 6 confirms that the control unit group 7 to control the RF tag reader-writer is registered in the device information list 62, and the control unit 2 other than the control unit 1 making the notification can control the RF tag reader-writer 4-2 because the control unit group 7 includes the control units 1 and 2 (step S71 of FIG. 9).

Since there is the control unit that can control the RF tag reader-writer 4-2, the control unit 6 notifies the RF tag reader-writer information including the setting information and the status information to the control unit 2 to control the RF tag reader-writer 4-2 (step S72 of FIG. 9). The control unit 2 determines whether or not the RF tag reader-writer 4-2 is controllable by referring to the information of the RF tag reader-writer 4-2 received from the control unit 6 (step S61 of FIG. 9). If the RF tag reader-writer 4-2 is controllable, the control unit 2 returns a controllable code to the control unit 6 (step S62 of FIG. 9). On the other hand, if the RF tag reader-writer 4-2 is uncontrollable, the control unit 2 returns an uncontrollable code to the control unit 6 (step S65 of FIG. 10).

If the control unit 6 receives a notification of being controllable from the control unit 2, the control unit 6 notifies the control unit 1 to release the control of the RF tag reader-writer 4-2. The control unit 1 releases the control of the RF tag reader-writer 4-2 and cuts off the connection (step S54 of FIG. 9).

Next, the control unit 1 notifies the control unit 6 that the RF tag reader-writer 4-2 is disconnected (step S55 of FIG. 9). The control unit 6 receiving a notification from the control unit 1 rewrites the status information of the RF tag reader-writer 4-2 in the device information list 62 with status information that the control unit 1 disconnects (step S73 of FIG. 9). Thereafter, the control unit 6 notifies the control unit 2 to control the RF tag reader-writer 4-2. The control unit 2 connects to the RF tag reader-writer 4-2 and tries to control the RF tag reader-writer 4-2 (step S63 of FIG. 9).

The control unit 2 determines whether or not the RF tag reader-writer 4-2 can be normally controlled (step S64 of FIG. 9). If the RF tag reader-writer 4-2 is controllable, the control unit 2 adds the RF tag reader-writer 4-2 to the device state list 22 of the control unit 2 and changes the status information into the control of the control unit 2. Thereafter, the control unit 2 notifies the control unit 6 that the RF tag reader-writer 4-2 can be normally controlled. The control unit 6 rewrites the status information of the RF tag reader-writer 4-2 in the device information list 62 with status information that the control unit 2 controls (step S74 of FIG. 9), and the operation is ended.

Thereby, the control unit 1 controls the RF tag reader-writer 4-1, and the control unit 2 controls the RF tag reader-writers 4-2 to 4-4. Hence, the external system 3 can acquire the information of the RF tags 5-1 to 5-4 from the RF tag reader-writers 4-1 to 4-4 through the control units 1, 2 and 6.

If the control unit 2 cannot control the RF tag reader-writer 4-2, the control unit 2 notifies the control unit 6 of being uncontrollable (step S65 of FIG. 10). In this case, the control unit 6 that is the upper-level control unit searches the control unit list 61 and the device control list 62 for other control unit (step S71 of FIG. 9). If there is any other control unit that can control the RF tag reader-writer, the control unit 6 can switch the control of the RF tag reader-writer 4-2 by repeating the same procedure as above.

However, if there is no more control unit to be notified, the control unit 6 that is the upper-level control unit rewrites the status information of the RF tag reader-writer 4-2 in the device information list 62 with status information that the control unit 1 is uncontrollable (step S75 of FIG. 10), and the operation is ended. In this embodiment, even if two or more control units are provided, the RF tag reader-writers 4-1 to 4-4 can be switched by performing these operations.

Thus, in this embodiment, the information can be continually acquired from the RF tags 5-1 to 5-4 using the control unit 6 that is the upper-level control unit for the control units 1 and 2 for controlling the RF tag reader-writers 4-1 to 4-4 without changing the external system 3 at all. Since the lower-level control units 1 and 2 need to have only the information of the control unit 6 that is the upper-level control unit, the amount of information is reduced. Further, in this embodiment, since the control is switched by the control unit 6 that is the upper-level control unit, there is no need of sharing the state between the lower-level control units 1 and 2.

Though one control unit group 7 is provided in this embodiment, two or more control unit groups may be employed. Also, though the control units 1 and 2 are registered in the control unit group, three or more control units may be registered. Further, the control for the RF tag reader-writers 4-1 to 4-4 may be switched according to the order of priority, using the order of priority for switching the control units 1 and 2 in this embodiment.

### Embodiment 5

A fifth embodiment of the present invention will be described below. The configuration of a device control system according to the fifth embodiment of the present invention is the same as the device control system according to the fourth embodiment of the present invention as shown in FIG. 7. The organization of the control unit lists 11, 21 and 61 and the organization of the device information lists 12, 22 and 62 are the same as shown in FIG. 8.

However, this embodiment is different from the fourth embodiment of the present invention in that the periodical communication is made between the control unit 6 and the control units 1, 2 to supervise the control units 1, 2 and 6 mutually. If there is no notification from the control units 1, 2 or there is no reply to the notification, the control unit 6 detects that the control unit 1 or 2 fails.

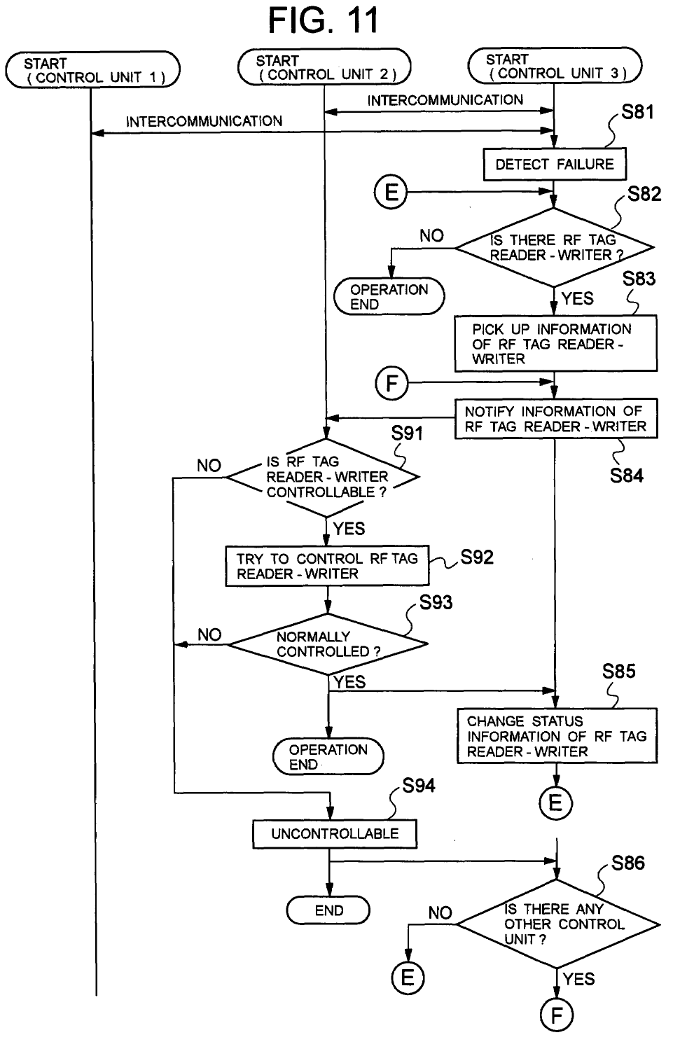

FIG. 11 is a flowchart showing the operation of the control units 1, 2 and 6 according to the fifth embodiment of the present invention. Referring to FIGS. 7 and 11, the operation of the control units 1, 2 and 6 according to the fifth embodiment of the present invention will be described below. A process as shown in FIG. 11 is implemented by executing a program held in the storage units 10, 20 and 60 with the control parts 13, 23 and 63. In the following, the switching of the RF tag reader-writers 4-1 to 4-4 when the control unit 1 fails will be described below.

If the control unit 1 fails, the control unit 1 cannot make a notification of supervision or a reply to the notification of supervision to the control unit 6. The control unit 6 detects that the control unit 1 fails because it cannot make the communication with the control unit 1 (step S81 of FIG. 11).

The control unit 6 searches the device information list 62 for the RF tag reader-writer controlled by the control unit 1 (step S82 of FIG. 11). If the RF tag reader-writer exists, the control unit 6 picks up all the information of the RF tag reader-writer 4-1 because the control unit 1 which controls the RF tag reader-writers 4-1 and 4-2 is registered in the device information list 62 (step S83 of FIG. 11).

Also, the control unit 6, knowing that the RF tag reader-writer 4-1 is controlled by the control unit group 7, notifies all the information of the RF tag reader-writer 4-1 to the control unit 2 belonging to the control unit group 7 and instructs the control unit 2 to control the RF tag reader-writer 4-1 (step S84 of FIG. 11). The control unit 2 verifies the information of the RF tag reader-writer 4-1 sent from the control unit 6, and determines whether or not the RF tag reader-writer 4-1 is controllable (step S91 of FIG. 11). If the RF tag reader-writer 4-1 is controllable, the control unit 2 tries to control the RF tag reader-writer 4-1 using the setting information 4-1 (step S92 of FIG. 11).

The control unit 2 determines whether or not the RF tag reader-writer 4-1 can be normally controlled (step S93 of FIG. 11). If the RF tag reader-writer 4-1 can be normally controlled, the control unit 2 rewrites the status information of the RF tag reader-writer 4-1 in the device information list 22 with status information that the control unit 2 controls, and notifies the control unit 6 that the RF tag reader-writer 4-1 can be normally controlled. The control unit 6 receiving a notification from the control unit 2 rewrites the status information of the RF tag reader-writer 4-1 in the device information list 62 with the status information that the control unit 2 controls (step S85 of FIG. 11).

If the RF tag reader-writer 4-1 is uncontrollable, the control unit 2 rewrites the status information of the RF tag reader-writer 4-1 in the device information list 22 with status information that the control unit 2 is uncontrollable, and notifies the control unit 6 that the control unit 2 is uncontrollable (step S94 of FIG. 11). The control unit 6 searches for any other control unit belonging to the control unit group 7 (step S86 of FIG. 11).

If there is any other control unit, the control unit 6 notifies the information of the RF tag reader-writer 4-1 to its control unit again (step S84 of FIG. 11). If there is no other control unit, the control unit 6 rewrites the status information of the RF tag reader-writer 4-1 in the device information list 62 with uncontrollable status, examines the device information list 62, and searches for any other RF tag reader-writer controlled by the control unit 1 (step S82 of FIG. 11).

In this case, since the control unit 6 knows that the RF tag reader-writer 4-2 is controlled by the control unit 1, the same procedure as above is performed again. If the RF tag reader-writer does not exist, the control unit 6 ends the operation.

Thereby, in this embodiment, the control unit 6 that is the upper-level control unit enables the control unit 2 to control the RF tag reader-writers 4-1 to 4-4, and enables the external system 3 to acquire the information of the RF tags 5-1 to 5-4.

Thus, in this embodiment, the periodical communication is made between the control unit 6 that is the upper-level control unit and the lower-level control units 1, 2 to supervise the control units 1, 2 and 6 mutually, whereby even if the lower-level control unit 1 or 2 fails, the information of the RF tags 5-1 to 5-4 can be continually acquired.

In this embodiment, after the recovery from failure, the original control unit 1 regains control, or control may be returned at any time. Though two lower-level control units are provided in this embodiment, three or more control units maybe employed. Further, the control units to be switched may be assigned the order of priority and switched in accordance with the order of priority in this embodiment.

Though in the above embodiments of the present invention the control units 1, 2 and 6 are operated by individual programs to clarify the operation of the control units 1, 2 and 6, they may be integrated as one program, and the computer with the same configuration may be employed for the control units 1, 2 and 6.

What is claimed is:

1. A device control system comprising of a plurality of control units for controlling a device, wherein if a concentrated load or a failure is detected in any of said plurality of control units, said control units are switched so that the control of the device by the control unit for which the concentrated load or the failure is detected may be performed by another control unit.

2. The device control system according to claim 1, wherein each of said plurality of control units comprises means of notifying the information of the device controlled by a self unit to the other control units if the concentrated load or the failure is detected in the self unit, means of determining whether or not said device is controllable by the self unit if the information of said device is sent from the other control units, and means of trying to control said device if said device is determined to be controllable by the self unit.

3. The device control system according to claim 1, wherein each of said plurality of control units detects the occurrence of said concentrated load or the failure from an activity ratio of control means for the self unit by supervising said device and supervising the intercommunication with said device.

4. The device control system according to claim 1, wherein each of said plurality of control units notifies all the information of said device to another control unit if any occurrence of said concentrated load or the failure is detected.

5. The device control system according to claim 1, wherein each of said plurality of control units comprises means of periodically communicating with the other control units to supervise said plurality of control units, means of determining whether or not said device is controllable by the self unit based on the information of the device controlled by said other control unit if any occurrence of the concentrated load or the failure in said other control unit is detected, and means of trying to control said device if the device is determined to be controllable by the self unit.

6. The device control system according to claim 1, further comprising an upper-level control unit for controlling said plurality of control units, in which said upper-level control unit notifies the information of the device controlled by the control unit receiving a notification of occurrence of the concentrated load or the failure to the other control unit and instructs said other control unit to control said device at the time of receiving the notification of occurrence of the concentrated load or the failure in each of said plurality of control units.

7. The device control system according to claim 6, wherein each of said plurality of control units detects the occurrence of said concentrated load or the failure from the activity ratio of control means for the self unit by supervising said device and supervising the intercommunication with said device.

8. The device control system according to claim 1, further comprising an upper-level control unit for controlling said plurality of control units, in which said upper-level control unit comprises means of periodically communicating with each of said plurality of control units to supervise each of said plurality of control units, and means of notifying the information of the device controlled by one control unit to the other control unit and instructing said other control unit to control said device, if the concentrated load or the failure in said one control unit is detected.

9. The device control system according to claim 1, wherein said device is any one of an RF tag reader-writer for reading or writing the information for at least the RF (Radio Frequency) tag and sensor means of detecting the information.

10. A control unit for controlling a device, wherein if a concentrated load or a failure is detected in any one of a self unit and the control units, the control units are switched so that the control of the device by the control unit for which said concentrated load or the failure is detected may be performed by any one of the other control units.

11. The control unit according to claim 10, further comprising means of notifying the information of the device controlled by the self unit to another control unit if the concentrated load or the failure in the self unit is detected, means of determining whether or not said device is controllable by the self unit if the information of said device is sent from said another control unit, and means of trying to control said device if said device is determined to be controllable by the self unit.

12. The control unit according to claim 10, wherein the occurrence of the concentrated load or the failure is detected from the activity ratio of control means for the self unit by supervising said device and supervising the intercommunication with said device.

13. The control unit according to claim 10, wherein if any occurrence of the concentrated load or the failure is detected, all the information of said device is notified to another control unit.

14. The control unit according to claim 10, further comprising means of periodically communicating with another control unit to supervise the another control unit, means of determining whether or not said device is controllable by the self unit based on the information of the device controlled by said another control unit if any occurrence of the concentrated load or the failure in the another control unit is detected, and means of trying to control said device if said device is determined to be controllable by the self unit.

15. An upper-level control unit for controlling a plurality of control units, each of which controls a device, comprising means of notifying the information of the device controlled by the control unit receiving a notification of occurrence of a concentrated load or a failure to another control unit and instructing said another control unit to control said device at the time of receiving said notification of occurrence of the concentrated load or the failure in any of said plurality of control units.

16. The control unit according to claim 15, wherein each of said plurality of control units detects the occurrence of the concentrated load or the failure from the activity ratio of control means for the self unit by supervising said device and supervising the intercommunication with said device.

17. An upper-level control unit for controlling a plurality of control units, each of which controls a device, comprising means of periodically communicating with each of said plurality of control units and supervising each of said plurality of control units, and means of notifying the information of the device controlled by one control unit to the other control unit and instructing said other control unit to control said device if a concentrated load or a failure is detected in said one control unit.

18. The control unit according to claim 10, wherein said device is any one of an RF tag reader-writer for reading or writing the information for at least the RF (Radio Frequency) tag and sensor means of detecting the information.

19. A device control method for use in a device control system comprising of a plurality of control units for each controlling a device, comprising a switching step of switching said control units so that the control of the device by the control unit for which a concentrated load or a failure is detected may be performed by the other control unit if said concentrated load or said failure is detected in any of said plurality of control units.

20. The device control method according to claim 19, wherein each of said plurality of control units performs a step of notifying the information of the device controlled by the self unit to the other control unit if any occurrence of the concentrated load or the failure in the self unit is detected, a step of determining whether or not said device is controllable by the self unit if the information of said device is sent from the other control unit, and a step of trying to control said device if said device is determined to be controllable by the self unit.

21. The device control method according to claim 19, wherein each of said plurality of control units detects the occurrence of the concentrated load or the failure from an activity ratio of control means for the self unit by supervising said device and supervising the intercommunication with said device.

22. The device control method according to claim 19, wherein each of said plurality of control units notifies all the information of said device to another control unit if any occurrence of the concentrated load or the failure is detected.

23. The device control method according to claim 19, wherein each of said plurality of control units performs a step of periodically communicating with the other control units to supervise said plurality of control units, a step of determining whether or not said device is controllable by the self unit based on the information of the device controlled by said other control unit if any occurrence of the concentrated load or the failure in said other control unit is detected, and a step of trying to control said device if said device is determined to be controllable by the self unit.

24. The device control method according to claim 19, wherein an upper-level control unit for controlling the plurality of control units is provided to perform a step of notifying the information of the device controlled by one control unit receiving a notification of occurrence of the concentrated load or the failure to the other control unit and instructing said other control unit to control said device at the time of receiving the notification of occurrence that the concentrated load or the failure occurs in each of said plurality of control units.

25. The device control method according to claim 24, wherein each of said plurality of control units detects the occurrence of the concentrated load or the failure from the activity ratio of control means for the self unit by supervising said device and supervising the intercommunication with said device.

26. The device control method according to claim 19, wherein an upper-level control unit for controlling the plurality of control units is provided to perform a step of periodically communicating with each of said plurality of control units to supervise each of said plurality of control units, and a step of notifying the information of the device controlled by one control unit to the other control unit and instructing said other control unit to control said device if the concentrated load or the failure in said one control unit is detected.

27. The device control method according to claim 19, wherein said device is any one of an RF tag reader-writer for reading or writing the information for at least the RF (Radio Frequency) tag and sensor means of detecting the information.

28. A recording medium recording a program for a device control method for use in a control unit for controlling a device, said program being executed on a computer, said program comprising a process of notifying the information of the device controlled by the control unit to the other control unit if any occurrence of the concentrated load or the failure in the control unit is detected, a process of determining whether or not said device is controllable by said control unit if the information of said device is sent from the other control unit, and a process of trying to control said device if said device is determined to be controllable by said control unit.

29. A recording medium recording a program for a device control method for use in an upper-level control unit for controlling a plurality of control units for each controlling a device, said program being executed on a computer, said program comprising a process of notifying the information of the device controlled by the control unit receiving a notification of occurrence of a concentrated load or a failure to the other control unit and instructing said other control unit to control said device at the time of receiving the notification of occurrence that the concentrated load or the failure occurs in any of said plurality of control units.

30. A recording medium recording a program for a device control method for use in an upper-level control unit for controlling a plurality of control units for each controlling a device, said program being executed on a computer, said program comprising a process of periodically communicating with each of said plurality of control units to supervise each of said plurality of control units, and a process of notifying the information of the device controlled by one control unit to the other control unit and instructing said other control unit to control said device at the time of detecting the occurrence of the concentrated load or the failure in said one control unit.
